(19) United States
(12) Patent Application Publication
(10) Pub. No.: US 2002/0135463 A1
(43) Pub. Date: Sep. 26, 2002

(54) Network transmitter

(76) Inventor: Ronald Reyes, San Jose, CA (US)

Correspondence Address: SKJERVEN MORRILL LLP, 25 METRO DRIVE, SUITE 700, SAN JOSE, CA, 95110, US

(21) Appl. No.: 09/818,144

(22) Filed: Mar. 26, 2001

(51) Int. Cl. H04M 11/04

(52) U.S. Cl. 340/310.01

(57) ABSTRACT

A line driver including one or more ECL line receivers is provided to transmit high frequency (10 kHz to 100 MHz) analog or data signals over a distance of up to 300 meters over a metallic conductor. In one embodiment, the line receivers in the line driver are cascaded to perform class A amplification, when the input signal is less than a threshold value, and drives the output signals to ECL logic levels when the input signal exceeds the threshold value. In one embodiment, an unbalanced output is provided within consumer performance expectations to realize cost savings.

### BACKGROUND OF THE INVENTION

1. Field of the Invention

The present invention relates to high frequency transmission of data signals and analog signals (e.g., video and audio signals suitably modulated on a carrier). In particular, the present invention relates to delivering transmission carriers from 10 kHz to 100 MHz over any metallic conductor (e.g., conventional household telephone wiring and power wiring) at distances up to 300 meters while maintaining the integrity of the carrier signal with the least amount of signal attenuation and radiation.

2. Discussion of the Related Art

Twenty-five years ago, complementary metal oxide semiconductor (CMOS) circuits were developed to handle many of the tasks that emitter-coupled logic (ECL) circuits were performing—tasks that were at frequencies well below 100 MHz. CMOS devices could handle these frequencies while consuming much less power than corresponding circuits implemented in ECL. Thus, CMOS was the preferred technology for many of the applications developed then that required less power (e.g., battery-operated systems such as watches radios and calculators) and were within the frequency capabilities of the CMOS circuits at the time.

In recent years, frequency requirements increased many folds due to higher clock speeds, which require more stable oscillators. Up till now, CMOS remains the dominant technology.

### SUMMARY OF THE INVENTION

According to one embodiment of the present invention, a line driver device is provided, including: (a) an input terminal; (b) an AC-coupling input stage coupled between the input terminal and a ground reference to provide a differential input signal; (c) an emitter-coupled logic (ECL) line driver circuit receiving the differential input signal to provide an amplified output differential signal; and (d) an AC-coupling output stage coupling the amplified output differential signal to a transmission medium.

In one implementation, the ECL line driver is provided by cascading ECL line receivers. Input impedance is matched by providing in the AC-coupling input stage suitably sized resistors to couple between the input terminal and the ground reference. The line driver device can also include in its AC-coupled output stage a filter (e.g., a band pass filter) for limiting the output signal to carrier frequencies of a predetermined range of broadcast channels. To realize additional cost savings, in some applications, the filter is coupled only to one of the two signals in the amplified output differential signal, while maintaining output signal quality to with limits of consumer expectations.

In one implementation, the line driver further includes a choke circuit coupled to the ground reference for attenuating low frequency noise in the amplified output differential signal. The present invention is applicable for transmission over telephone, power and other metallic conductors.

According to one embodiment, the line driver device provides class A amplification when the input differential signal is less than a predetermined value.

The present invention is better understood upon consideration of the detailed description below and the accompanying drawings.

### BRIEF DESCRIPTION OF THE DRAWINGS

FIG. 1 shows telephone line adapter (TV/TLA) circuit 100, in accordance with one embodiment of the present invention.

### DETAILED DESCRIPTION OF THE PREFERRED EMBODIMENTS

Although ECL devices require substantially more power than corresponding CMOS devices at lower frequencies, unlike CMOS devices, the power demand of ECL devices does not increase with the operating frequency. Even though CMOS circuits have been designed for higher speeds, ECL devices maintain approximately seven times faster than the current state of the art CMOS devices, such as those CMOS devices used in low voltage differential signaling (LVDS) applications as point-to-point communication circuits. (LVDS is based on EIA-644 Specification of the Electronic Industries Association). Unlike CMOS devices, load currents in ECL devices do not change. Consequently, ECL devices have stable 2-port transmission and reflection characteristics, which result in significant cost and design advantages. Further, the output swing (i.e., the voltage difference between logic high and logic low representations) of ECL devices has been maintained over the years. In contrast, to reduce power consumption, CMOS devices are now designed to operate at much smaller output swings, thus making them more susceptible to noise. Finally, an ECL device can drive a 1 GHz signal in a 75-ohm coaxial cable for hundreds of meters while the corresponding CMOS device can only drive a signal for about 10 meters, under comparable operating conditions.

Another bipolar transistor-based technology is the millimeter integrated circuits (“MMIC devices”). MMIC devices have been successfully used in high frequency transmission of audio, video and data signals. One example of such an application of MMIC devices can be found in co-pending U.S. patent application (“Co-pending Application”), entitled “System and Method for Power Line Communication,” Ser. No. 09/547,954, filed Apr. 11, 2000, assigned to Power Line Networks, Inc., which is also the Assignee of the present application. The disclosure of the Co-pending Application is hereby incorporated by reference in its entirety. In a system described in the Co-pending Application, an NTSC (National Television Standards Committee) format video signal is transmitted using Vestigial Sideband (VSB) modulation at carrier frequencies of 61.25 MHz and 67.25 MHz (i.e., corresponding to the frequencies of channels 3 and 4, respectively). In that system, a radio frequency (RF) source (e.g., an RF Out connector from a video cassette recorder) places the video signal on the AC power distribution line to be received into a passive receiver connected to a standard television receiver through an antenna RF input F type connector.

Unlike ECL devices, MMIC devices have a high signal-to-noise ratio at very high signal gains, which make them a logical choice for RF “front ends.” In addition, depending on the substrate composition and power requirements, MMIC devices also have relatively flat frequency response characteristics between 0 to 25 GHz. MMIC devices can also be cascaded practically without concern for side effects arising from a relatively high voltage standing wave ratio (VSWR), making MMIC devices suitable for delivering high power with low signal levels. However, in an MMIC device, the load still controls the circuit power demand and s-parameters (i.e., transmission line characteristics) in an MMIC device are complicated. Further, highly stable MMIC devices are expensive and require even higher power. Consequently, even though MMIC devices are used in class-A RF power amplifiers, ECL devices are more economical.

Thus, one embodiment of the present invention described below uses ECL devices for transmission over relatively long distance (e.g., throughout the telephone wiring of a home). One type of commercially available ECL circuits is marketed by Motorola Corporation under the trade name “MECL”. Through circuit design techniques and an oxide-isolated process, MOSAIC (Motorola Oxide Self-Aligned Implated Circuits), higher speed digital devices are created without increasing power consumption. MOSAIC allows smaller device geometry, improved bandwidth and reduced parasitic capacitance while maintaining lower costs.

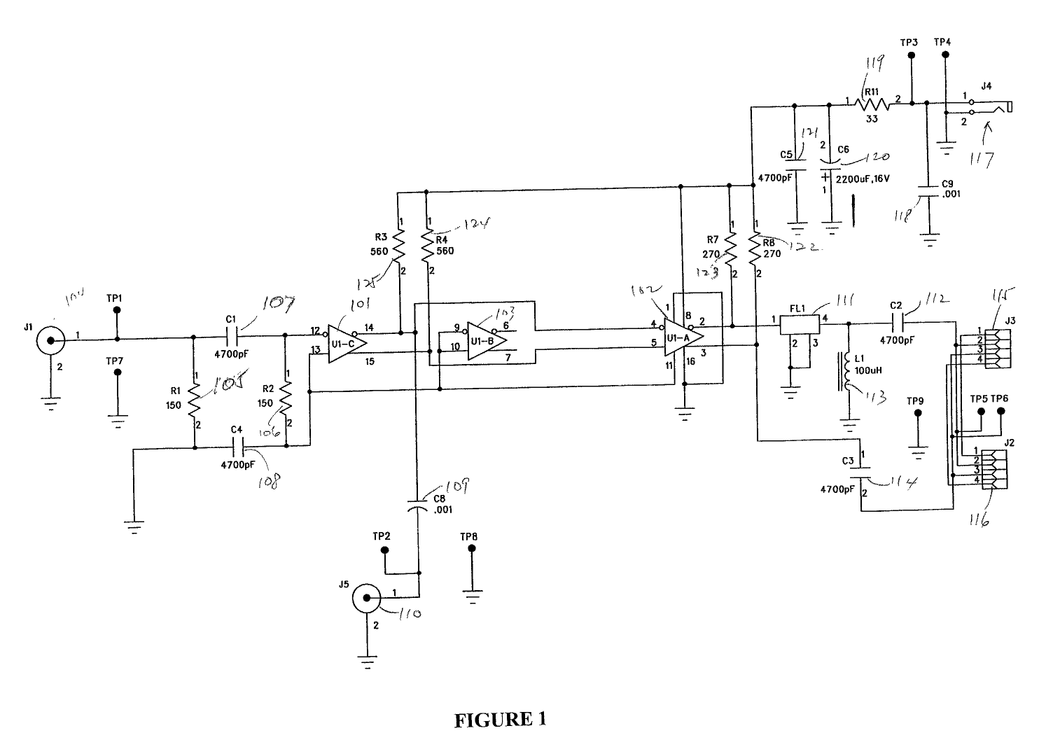

FIG. 1 shows telephone line adapter (TV/TLA) 100 according to one embodiment of the present invention. As shown in FIG. 1, telephone line adapter 100 includes cascaded line receivers 101 and 102. Line receivers 101 and 102 can be provided by two of the three line receivers in an MC10H116 integrated circuit, which can be obtained from Motorola Corporation in a “dual inline package” (DIP) or a “small outline integrated circuit” (SOIC) package. Each of line receivers 101 and 102 amplifies signals of 50 millivolts (mV) or less as a class A amplifier, while signals higher than 50 mV are amplified to MECL logic levels. Consequently, line receivers 101 and 102 amplify all signals below 50 mV in the manner of an 8 to 10 db class-A amplifier. When the signals are greater than 50 mV, line receivers 101 and 102 act like a digital line driver. An output terminal 110 is provided from the output terminals of line receiver 101. This output terminal provides an amplified copy of the input signal received at terminal 104 to facilitate some applications. For example, an input cable television cable previously connected to a video cassette recorder (VCR) can now be connected to terminal 104 for distribution throughout a house, while the local TV receives its input signal from terminal 110.

As illustrated FIG. 1, line receiver 101 receives an input signal from an external signal source represented by connector 104. The input signal is AC-coupled to the differential input terminals of line receivers 101 by capacitors 107 and 108 to accommodate input signals that are within ±400 mV of an internal reference voltage V_{bb}. As shown in FIG. 1, the input impedance to line receiver 101 is provided by resistors 105 and 106, each 150 ohms, which is twice the desired input impedance between AC-coupling capacitors 107 and 108. Resistors 105 and 106 form a 75-ohm termination for the source signal at connector 104. (Of course, the impedance values shown in FIG. 1 can be easily adjusted to accommodate any line impedance.)

TV/TLA circuit 100 is supplied by a voltage source at power connector 117. Capacitors 118, 120 and 121 and resistor 119 eliminates high frequency noise from the voltage source, thus performing a power regulator function. The differential output terminals of line receivers 101 and 102 are pulled up by resistors 124 and 125, and resistors 122 and 123, respectively.

The bandwidth of TV/TLA circuit 100 depends upon external components and its device selection. A judicious choice of the line receivers to be used and the associated rise times can provide a stable wideband amplifier. In designing TV/TLA circuit 100, the switching action of line receivers 101 and 102 is the primary design objective. If inter-stage gain between line receivers 101 and 102 in TV/TLA circuit 100 becomes unstable due to poor layout, supply decoupling, or stage loads, TV/TLA circuit 100 can go into oscillation during a level transition. Transitional instability in TV/TLA circuit 100 can happen when the input connector is disconnected or even if a mismatch causes VSWRs to exceed 3. For these reasons only two of the three line-receivers in the integrated circuit are cascaded (i.e., line receiver 103 is not connected).

In this instance, the MClOH116 integrated circuit is designed for point-to-point communications. To provide point-to-multipoint capability, two coupling capacitors 112 and 114 are provided to couple the output signals of line receiver 102 to the tip and ring pair of a telephone line, so as to avoid the high DC telephone line voltages, such as the high voltages generated by a telecommunications (“Telco”) ring signal. In addition, capacitors 112 and 114 provide a cost-effective way to apply the output signals of line receiver 102 to the 600-ohm phone line, in compliance with Telco regulations. Impedance matching in this instance is not critical, since the transmission distance is well within the drive capability of the selected ECL devices. More precise impedance matching to the telephone line will allow transmission over greater distances even at non-logic signal levels.

As shown in FIG. 1, the output signal of line receiver 102 is not provided in this embodiment as a balanced output differential signal. In this implementation, a single output filter 111, which passes the frequencies of broadcast channels 3 and 4 from an output terminal of line receiver 102, is provided. (As shown in FIG. 1, filter 111 is connected to only one of the differential output terminals of line receiver 102.) A 100 μh choke 113 is provided between the output terminal of filter 111 and the ground reference to remove low frequency noise generated by the power supply and coupled through filter 111. Ideally, both output terminals of line receiver 102 should be filtered to maintain AC line balance. However, since the single filter provides adequate support for the intended consumer video extender application, the cost savings of one output filter is realized. In fact, as implemented in FIG. 1, TV/TLA circuit 100 outperforms prior art non-ECL circuits. The output signals of capacitors 112 and 114 are provided to tip and ring pairs 115 and 116 using standard RJ-11 type connectors 115 and 116.

Although the detailed description above is provided in conjunction with specific embodiments of the present invention, the detailed description should not be taken as limiting. For example, even though the telephone wiring and the power lines used in a particular household may have very different electrical characteristics, TV/TLA circuit 100 can be used for transmission in both media. Numerous other variations and modifications within the scope of the present application are possible. The present invention is set forth in the following claims.

I claim:

1. A line driver device, comprising:
an input terminal;
an AC-coupling input stage coupled between said input terminal and a ground reference, said AC-coupling input stage receiving an input signal from said input terminal and providing a differential input signal;
an emitter-coupled logic (ECL) line driver circuit receiving said differential input signal to provide an amplified output differential signal; and
an AC-coupling output stage coupling said amplified output differential signal to a transmission medium.

2. A line driver device as in claim 1 wherein said ECL line driver comprises a plurality of cascaded line receivers.

3. A line driver device as in claim 1 wherein said AC-coupling input stage further comprises resistors coupled between said input terminal and said ground reference.

4. A line driver device as in claim 3 wherein said resistors each having a resistance selected to provide a predetermined input impedance at said input terminal.

5. A line driver device as in claim 1 wherein said AC-coupling output stage further comprises a filter coupled to receive said amplified output differential signal.

6. A line driver as in claim 5 wherein said filter is coupled only to one of the two signals in said amplified output differential signal.

7. A line driver as in claim 5, wherein said filter has a pass band passing a carrier frequency of a broadcast channel.

8. A line driver as in claim 1, further comprises a choke circuit coupled to said ground reference for attenuating low frequency noise in said amplified output differential signal.

9. A line driver device as in claim 1 wherein said amplified differential output signals are provided to a transmission medium comprising telephone wiring.

10. A line driver device as in claim 1 wherein said amplified differential output signals are provided to a transmission medium comprising power wiring.

11. A line driver device as in claim 1, further comprises a power regulator circuit.

12. A line driver device as in claim 1, wherein said ECL line driver circuit provides class A amplification when said input differential signal is less than a predetermined value.
